(19) United States
(12) Patent Application Publication
(10) Pub. No.: US 2023/0334359 A1
(43) Pub. Date: Oct. 19, 2023

(54) DETERMINING INCREASED VALUE BASED ON HOLDOUT IMPRESSIONS

(71) Applicant: Meta Platforms, Inc., Menlo Park, CA (US)

(72) Inventors: Joseph Poj Davin, Daly City, CA (US); Andrew Donald Yates, San Francisco, CA (US)

(21) Appl. No.: 15/973,244

(22) Filed: May 7, 2018

(51) Int. Cl. G06N 99/00; G06N 7/00

(52) U.S. Cl. CPC G06N 99/005; G06N 7/005

(57) ABSTRACT

A system receives a first plurality of impressions associated with a first set of features. Labels for the first plurality is generated based on the first set of features. A machine learning model is trained based on the first set of features and the labels. A second plurality of impressions associated with a second set of features is received. A first estimated probability measuring conversion likelihood when impression delivery occurs is generated based on applying the second plurality and the second set of features to the model. A plurality of holdout impressions associated with a third set of features is identified. A second estimated probability measuring conversion likelihood when impression delivery is withheld is generated based on applying the plurality of holdout impressions and the third set of features to the model. Increased valued (e.g., lift) is estimated based on subtracting the second estimated probability from the first estimated probability.

### BACKGROUND

This disclosure relates generally to online systems, and in particular, to determining an estimated increase in value within online systems based on holdout impressions.

An online system, such as a social networking system, can allow its users to connect to and to communicate with other online system users. Via the online system, users can create profiles or accounts that are tied to their identities and that include information about the users, such as interests and demographic data. The users may be individuals (e.g., people) or entities (e.g., corporations, organizations). Because of the increasing popularity of online systems and the increasing amount of user-specific information maintained by online systems, online systems can provide an ideal forum for content providers to increase awareness about products or services by presenting content items to online system users.

Presenting content items to users of an online system can allow a content provider to promote products, services, opinions, and/or causes. Often times, it can be beneficial to gain insight as to how much additional value is provided to a content provider when one or more content items are presented to users via the online system as opposed to when content items are not presented to the users via the online system. However, under conventional approaches specifically arising in the realm of computer technology, it can be difficult for an online system to accurately determine or approximate how much value is added when content is presented to users via the online system as opposed to when content is not presented. Moreover, in accordance with conventional approaches, it can be difficult to accurately determine or approximate such added value without significantly affecting other circumstances associated with content presentation.

### SUMMARY

An online system, such as a social networking system, can be utilized by a plurality of users. Users of the online system can be content providers who provide content, such as text, images, video, audio, and/or advertisements, etc. Users of the online system can also access, consume, view, engage with, and/or otherwise interact with content made available by content providers. For example, a content provider such as an advertiser can spend money in order to present, publish, post, and/or provide an advertisement via the online system for other users of the online system to view, engage with, and/or otherwise access. However, under conventional approaches specifically arising in the realm of computer technology, it can be challenging for the online system to determine or estimate how much additional value is provided to a content provider when one or more content items are presented to users via the online system as opposed to when content items are not presented to the users. For example, an advertiser can provide an advertisement for the online system to present to a user of the online system. In this example, a conversion eventually occurs with respect to the user. However, in some cases, perhaps the user would have converted even if the advertisement was not presented to the user via the online system. Moreover, with conventional approaches, a conversion that occurs outside a given time period (e.g., 24 hours) may not be properly attributed to an impression. As such, in accordance with conventional approaches, it can be difficult to accurately determine or approximate how much credit should be attributed to the online system for the conversion. Furthermore, under conventional approaches, it can be challenging to accurately determine or approximate an additional value potentially provided to the content provider by the online system, without significantly impacting various circumstances (e.g., revenue, modeling, etc.) associated with content presentation.

Various embodiments of the present disclosure can determine or estimate an increase in value (e.g., monetary value), from which an effective conversion rate can be derived. The increase in value can, for instance, be in response to advertising or promotion efforts. In some cases, the increase in value is referred to as lift. The estimated increase in value, or lift, can aim to take into consideration how likely users would have converted even if they were not presented with advertising or promotional content via an online system. For example, the online system can determine a first conversion rate when content items such as advertisements are presented to users, determine a second conversion rate when content items are not presented to users, and determine an effective conversion rate based on (i.e., based at least in part on) the difference between the first conversion rate and the second conversion rate.

In some implementations, the online system receives a first plurality of impressions associated with a first set of features. The first plurality of impressions can correspond to a first plurality of ad impressions presented to users. In some cases, the first plurality of ad impressions is matched with a first set of events, which can be associated with conversions. The online system generates a set of labels for the first plurality of impressions based on (i.e., based at least in part on) the first set of features. The set of labels can be generated further based on data associated with the first set of events. The labels indicate whether or not, and/or to what extent, each of the first plurality of impressions can be attributed for a conversion. The first set of features, the first set of events, and/or the set of labels can be utilized as training data or samples for training a model via machine learning. In an example, the online system trains a machine learning model based on the first set of features and the set of labels.

Furthermore, in some embodiments, the online receives a second plurality of impressions associated with a second set of features. The second plurality of impressions can correspond to a second plurality of ad impressions presented to users. The online system applies (e.g., inputs) the second plurality of impressions and the second set of features to the trained machine learning model. As a result, the machine learning model generates (i.e., determines, computes, produces, outputs, etc.) a first estimated probability measuring conversion likelihood when impression delivery occurs. The online further identifies a plurality of holdout impressions associated with a third set of features. In some instances, the holdout impressions can be referred to as “shadow” impressions or “counterfactual” impressions. The holdout impressions are associated with a control group, where impression delivery is withheld for the control group (e.g., such holdout impressions are not delivered or presented to users). The online system applies the plurality of holdout impressions and the third set of features to the trained machine learning model to generate a second estimated probability measuring conversion likelihood when impression delivery is withheld. The online system further subtracts the second estimated probability from the first estimated probability to generate an estimated metric measuring lifetime lift (i.e., an increase in value over time).

It should be appreciated that many other features, applications, embodiments, and/or variations of the disclosed technology will be apparent from the accompanying drawings and from the following description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a block diagram of an example system environment in which an example online system operates, in accordance with an embodiment.

FIG. 2 illustrates a block diagram of an example online system, in accordance with an embodiment.

FIG. 3 illustrates a block diagram of an example lift determination module, in accordance with an embodiment.

FIG. 4 illustrates a block diagram of an example scenario associated with determining increased value based on holdout impressions, in accordance with an embodiment.

FIG. 5 illustrates a flowchart describing an example process associated with determining increased value based on holdout impressions, in accordance with an embodiment, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

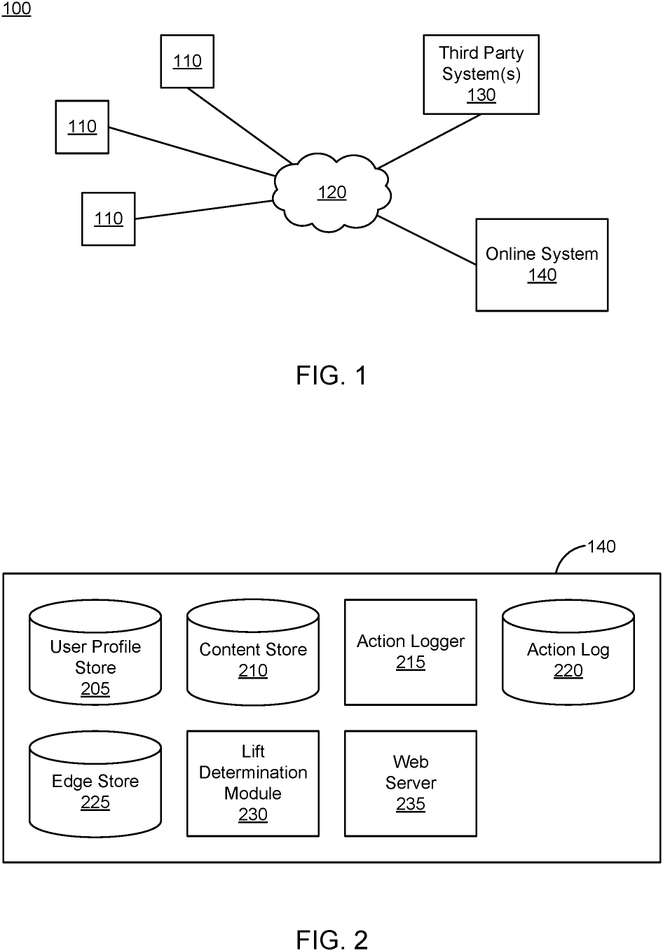

FIG. 1 illustrates a block diagram of an example system environment 100 in which an example online system 140 operates, in accordance with an embodiment. The example system environment 100 shown in FIG. 1 can comprise one or more client devices 110, a network 120, one or more third party systems 130, and the online system 140. In alternative configurations, different and/or additional components may be included in and/or removed from the system environment 100. In some cases, the online system 140 can, for example, be a social networking system, a content sharing network, and/or another system for providing content to users of the system, etc.

The client devices 110 can be one or more computing devices or systems capable of receiving user input as well as transmitting and/or receiving data via the network 120. In one implementation, a client device 110 is a conventional computer system, such as a desktop or a laptop computer. Alternatively, a client device 110 may be a device having computer functionality, such as a personal digital assistant (PDA), a mobile telephone, a smartphone, a wearable device, or another suitable device. A client device 110 can be configured to communicate via the network 120. In one embodiment, a client device 110 executes an application allowing a user of the client device 110 to interact with the online system 140. For example, a client device 110 can execute an application provided by the online system or a browser application in order to enable interaction between the client device 110 and the online system 140 via the network 120. In another embodiment, a client device 110 can interact with the online system 140 through an application programming interface (API) running on a native operating system of the client device 110, such as IOS® or ANDROID™. It should be understood that many variations are possible.

The client devices 110 can be configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 can include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

Moreover, one or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on a client device 110. In other embodiments, a third party system 130 provides content or other information for presentation via a client device 110. A third party system 130 may also communicate information to the online system 140, such as advertisements, content, or information about an application provided by the third party system 130.

FIG. 2 illustrates a block diagram of an example online system 140, in accordance with an embodiment. The online system 140 shown in FIG. 2 can include a user profile store 205, a content store 210, an action logger 215, an action log 220, an edge store 225, a lift determination module 230, and a web server 235. In other embodiments, the online system 140 may include additional, fewer, or different components/modules for various applications. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, modules can be implemented, in part or in whole, as software running on one or more computing devices or systems, such as on a user or client computing device. For example, a module or at least a portion thereof can be implemented as or within an application (e.g., app), a program, an applet, or an operating system, etc., running on a user computing device or a client/user computing system. In another example, a module or at least a portion thereof can be implemented using one or more computing devices or systems which can include one or more servers, such as network servers or cloud servers. In some instances, a module can, in part or in whole, be implemented within or configured to operate in conjunction with a social networking system (or service), such as the online system 140 or the social networking system. Moreover, conventional components such as network interfaces, security functions, load balancers, failover servers, management and network operations consoles, etc., are not explicitly shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity’s user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third party applications or third party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content can be text, image, audio, video, or any other suitable data presented to a user. In various embodiments, the content also specifies a page of content. For example, a content item can include a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

In various embodiments, a content item includes various components capable of being identified and retrieved by the online system 140. Example components of a content item include a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items may include an objective identifying an interaction that a user associated with a content item desires other users to perform when presented with content included in the content item. Example objectives include installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Further, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user’s interactions with advertisements on the online system 140 as well as with other applications operating on the online system 140. In some embodiments, data from the action log 220 is used to infer interests or preferences of a user, augmenting the interests included in the user’s user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 can be uniquely identifiable, e-commerce websites, such as in the preceding example, may communicate information about a user’s actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users’ real-life relationships, such as friends, coworkers, partners, and so forth. Other edges are generated when users interact with objects in the online system 140, such as expressing interest in a page on the online system 140, sharing a link with other users of the online system 140, and commenting on posts made by other users of the online system 140. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user’s interest in an object or in another user in the online system 140 based on the actions performed by the user. A user’s affinity may be computed by the online system 140 over time to approximate the user’s interest in an object, in a topic, or in another user in the online system 140 based on actions performed by the user. Computation of affinity is further described in U.S. Pat. Application No. 12/978,265, filed on Dec. 23, 2010, U.S. Pat. Application No. 13/690,254, filed on Nov. 30, 2012, U.S. Pat. Application No. 13/689,969, filed on Nov. 30, 2012, and U.S. Pat. Application No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

Furthermore, the lift determination module 230 can be configured to facilitate receiving a first plurality of impressions associated with a first set of features. The lift determination module 230 can further facilitate generating a set of labels for the first plurality of impressions based on (i.e., based at least in part on) the first set of features. In some embodiments, the first plurality of impressions associated with the first set of features and the set of labels serve as training data/samples. Utilizing one or more machine learning processes, the lift determination module 230 facilitates training a machine learning model based on (i.e., based at least in part on) the first set of features and the set of labels. The lift determination module 230 can also be configured to facilitate receiving a second plurality of impressions associated with a second set of features. The lift determination module 230 can generate, based on applying or inputting the second plurality of impressions and the second set of features to the machine learning model, a first estimated probability measuring conversion likelihood when impression delivery occurs. The first estimated probability can correspond to an approximate conversion rate of users when impressions are delivered to those users.

Moreover, in some embodiments, the lift determination module 230 identifies a plurality of holdout impressions associated with a third set of features. In some cases, the holdout impression are “shadow” impressions or “counterfactual” impressions that are part of a control-group. The holdout impressions can be placeholders for actual impressions, since these holdout impressions are withheld from being delivered. The lift determination module 230 can facilitate generating, based on applying the plurality of holdout impressions and the third set of features to the machine learning model, a second estimated probability measuring conversion likelihood when impression delivery is withheld. The second estimated probability can correspond to an approximate conversion rate when impressions are withheld from being delivered, under similar circumstances associated with calculating the first estimated probability. For instance, the second estimated probability can attempt to measure the likelihood that the users would convert even when the impressions are not delivered to them, given that all other circumstances are equal. As such, the holdout impressions can enable the online system to approximate counterfactual conditions/qualities.

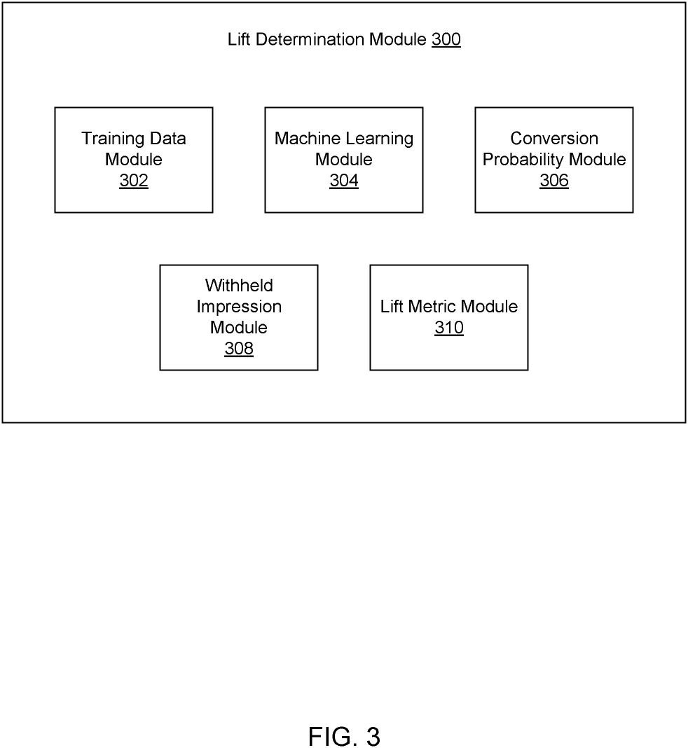

Further, the lift determination module 230 can be configured to facilitate generating, based on subtracting the second estimated probability from the first estimated probability, an estimated metric measuring lifetime lift, which can indicate how much value is added by the online system via content presentation (e.g., impression delivery). Additionally, in some cases, an effective cost per mile metric can be produced based on the estimated metric measuring lifetime lift. More details regarding the lift determination module 230 are provided below with reference to FIG. 3. It should also be understood that many variations are possible. For instance, it should be appreciated that, in some embodiments, one or more functions of the lift determination module 230 can be performed by other modules/components of the online system 140. Also, in some implementations, the lift determination module 230 can perform one or more functions of another component(s)/module(s) in the online system 140.

Additionally, the web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or Blackberry OS.

FIG. 3 illustrates a block diagram of an example lift determination module 300, in accordance with an embodiment. In some cases, the example lift determination module 300 can be implemented as the lift determination module 230, described above. As shown in FIG. 3, the example lift determination module 300 includes a training data module 302, a machine learning module 304, a conversion probability module 306, a withheld impressions module 308, and a lift metric module 310.

The training data module 302 can be configured to facilitate receiving (i.e., acquiring, obtaining, collecting, gathering, identifying, and/or forming, etc.) training data useful for determining increased value, such as lift, based on holdout impressions. In some embodiments, the training data module 302 receives a first plurality of impressions associated with a first set of features. For example, the first plurality of impressions can correspond to a first collection of ad impressions. The online system 140 can include an ad logger component. The training data module 302 can include, can be included in, and/or can otherwise be operable with at least a portion of the ad logger component. Continuing with example, the ad logger component logs (i.e., identifies, tracks, monitors, records, etc.) the first plurality of impressions. The ad logger component also logs the first set of features associated with the first plurality of impressions. The first set of features can, for instance, include traits, attributes, properties, signals, characteristics, metadata, context data, historical data, content, and/or other types of information related to the first plurality of impressions. The training data module 302 can, via the ad logger component, generate one or more files for storing the first plurality of impressions and the first set of features.

In some implementations, the online system 140 includes an ad conversion component. In one instance, the training data module 302 can include, can be included in, and/or can otherwise be operable with at least a portion of the ad conversion component. The ad conversion component logs a stream of events. For example, the ad conversion component logs a first set of events, including information related to the first set of events (e.g., event identifiers, event types, identifiers for users who are involved with the events, and/or times at which the events occurs, etc.). The ad conversion component also matches the first set of events with the first plurality of impressions, such as by associating or attributing a particular event in the first set to a particular impression in the first plurality. The training data module 302 can, via the ad conversion component, generate one or more files for storing the first set of events, as well as the associated first plurality of impressions and the first set of features.

Moreover, the training data module 302 can also be configured to facilitate generating a set of labels for the first plurality of impressions based on the first set of features (and/or based on the first set of events). The set of labels for the first plurality of impressions can be generated by the training data module 302 based on a set of one or more label rules. In some cases, the set of one or more label rules includes at least one label rule that requires a respective conversion in a plurality of conversions to be attributed to each impression in the first plurality of impressions. For instance, event data can indicate conversions, such that the respective conversion can be determined to be attributed to each impression based on a respective event associated with each impression. In one example, the training data module 302 can apply a label rule that causes an impression to be labeled as a ‘1’ when an event matched with the impression indicates that there has been at least one conversion that is attributed to the impression, when a user interaction (e.g., click) occurred within 90 minutes from delivery of the impression, and when the at least one conversion occurred within 24 hours after the user interaction. In this example, impressions that do not satisfy these criteria specified in the rule are labeled as ‘0’. In some implementations, labels need not be binary. For instance, if a label rule has multiple criteria, then an impression can be labeled with a numeric value (e.g., from 0 and 1) based on how many criteria the impression satisfies. Further, in some cases, different criteria can be weighted differently.

Training data useful for determining increased value, such as lift, can thus be received by the training data module 302. The training data can include the first plurality of impressions, the first set of features, the first set of events, and/or the set of labels. The training data is utilized by the machine learning module 304 to train a machine learning model. In some embodiments, the machine learning module 304 applies one or more machine learning algorithms/processes to (at least in part) the first set of features and the set of labels to train the machine learning model. In some cases, the machine learning model is trained further based on the first set of events associated with the first plurality of impressions.

As part of the generation of the machine learning model, the machine learning module 304 can utilize the training data including a set of positive training data that have been labeled ‘1’ (or another numeric value greater than a specified threshold) based on their possession of certain property(ies) in question. For instance, the set of positive training data can include impressions with features that satisfy one or more label rules. Additionally or alternatively, in some embodiments, the machine learning module 304 can utilize training data including a set of negative training data that lack the property(ies) in question. For example, the set of negative training data can include impressions that have been labeled ‘0’ (or another numeric value less than a specified threshold) based on their features failing to satisfy criteria specified by the one or more label rules.

As discussed, the machine learning module 304 can utilize features (including feature values) from the training data, where the features are variables deemed potentially relevant to whether or not the data has the associated property or properties. An ordered list of the features is herein referred to as the feature vector. In one embodiment, the machine learning module 304 applies dimensionality reduction (e.g., via linear discriminant analysis (LDA), principle component analysis (PCA), etc.) to reduce the amount of data in the feature vectors to a smaller, more representative set of data.

In some implementations, the machine learning module 304 uses supervised machine learning to train the machine learning model, with the feature vectors of the positive training set (and/or the negative training set) serving as the inputs. Different machine learning techniques, such as linear support vector machine (linear SVM), boosting for other algorithms (e.g., AdaBoost), neural networks, logistic regression, naïve Bayes, memory-based learning, random forests, bagged trees, decision trees, boosted trees, and/or boosted stumps, may be used alone or in combination in different embodiments. The machine learning model, when applied to a feature vector, outputs an indication of how likely a conversion will occur, such as a Boolean yes/no estimate of whether an impression will cause the conversion, or a scalar value representing a probability that the impression will lead to the conversion, etc.

In some embodiments, a validation set is formed from additional data, other than those in the training set(s) which have already been determined to have, or to lack, the property(ies) in question. The machine learning module 304 can apply the trained machine learning model to the validation set to quantify the accuracy of the machine learning model. Common metrics applied in accuracy measurement include: Precision = TP / (TP + FP) and Recall = TP / (TP + FN), where precision is how many instances the machine learning model correctly predicted (TP or true positives) out of the total it predicted (TP + FP or false positives), and recall is how many instances the machine learning model correctly predicted (TP) out of the total number that did have the property(ies) in question (TP + FN or false negatives). The F score (F-score = 2 * PR / (P + R)) unifies precision and recall into a single measure. In one embodiment, the machine learning module 304 iteratively re-trains the machine learning model until the occurrence of a stopping condition, such as the accuracy measurement indication that the model is sufficiently accurate, or a number of training rounds having taken place, etc. It should be appreciated that there can be many variations associated with the disclosed technology.

Continuing with FIG. 3, the conversion probability module 306 can be configured to facilitate receiving a second plurality of impressions associated with a second set of features. In some implementations, the conversion probability module 306 includes, is included in, and/or is otherwise operable with the ad logger component of the online system 140. The conversion probability module 306 can receive, via the ad logger component, the second plurality of impressions corresponding to a second collection of ad impressions. In some cases, the second plurality of impressions is associated with a second set of events. The conversion probability module 306 can include, can be included in, and/or can otherwise be operable with the ad conversion component of the online system 140. The conversion probability module 306 can, via the ad conversion component, match the second set of events with the second plurality of impressions.

The conversion probability module 306 further works in conjunction with the machine learning module 304 to apply the second plurality of impressions and the second set of features to the machine learning model. Based on applying the second plurality of impressions and the second set of features to the machine learning model, the conversion probability module 306 generates a first estimated probability measuring conversion likelihood when impression delivery occurs. The first estimated probability approximates a conversion rate of users when the second plurality of impressions are delivered to those users. In some embodiments, the first estimated probability is generated further based on applying the second set of events to the machine learning model.

Moreover, the withheld impressions module 308 can be configured to facilitate identifying a plurality of holdout impressions associated with a third set of features. As discussed, the plurality of holdout impressions can be “shadow” impressions or “counterfactual” impressions. The holdout impressions can serve as placeholders (instead of impressions actually delivered) used for estimating a conversion rate for users when impression delivery is withheld for the users. The withheld impressions module 308 can operate in conjunction with the machine learning module 304 to facilitate applying the plurality of holdout impressions and the third set of features to the machine learning model. Based on applying the plurality of holdout impressions and the third set of features to the machine learning model, the withheld impressions module 308 generates a second estimated probability measuring conversion likelihood when impression delivery is withheld. Furthermore, in some instances, the plurality of holdout impressions is associated with a third set of events. In such instances, the withheld impressions module 308 and the machine learning module 304 can be operable in conjunction to generate the second estimated probability further based on applying the third set of events to the machine learning model.

In some embodiments, each holdout impression in the plurality of holdout impressions is associated with a particular user. In such embodiments, the withheld impressions module 308 can identify the plurality of holdout impressions based on each user associated with each holdout impression in the plurality of holdout impressions. For instance, each impression in the second plurality of impressions is associated with a respective user. The withheld impressions module 308 can identify, based on matching user features/characteristics within an allowable deviation, a group of users who are similar to the respective users associated with the second plurality of impressions. Each similar user in the identified group of users can be a particular user associated with each holdout impression in the plurality of holdout impressions. The withheld impressions module 308 thus identifies each holdout impression based on each particular user in the identified group. The withheld impressions module 308 further withholds impression delivery for each user associated with each holdout impression in the plurality of holdout impressions.

In one example, for each user associated with each impression in the second plurality of impressions, a similar user can be identified. A set of identified similar users can form a control-group, where impressions are not delivered to the set of identified similar users of the control-group. In this example, an estimated probability measuring conversion likelihood is generated based on information associated with the set of identified similar users. However at impression delivery time, the withheld impressions module 308 recognizes that the set of identified similar users are part of the control-group and thus withholds impression delivery.

Moreover, in some embodiments, each holdout impression in the plurality of holdout impressions is withheld from undergoing one or more auction processes (i.e., bidding processes). As a result, the second estimated probability measuring conversion likelihood associated with withheld impression delivery is nonetheless determinable without having to run a “shadow” auction(s). This is because the set of similar users is identified to be sufficiently similar to the users associated with the second plurality of impressions such that the second plurality of impressions would have likely been provided to the set of identified similar users had they not been placed in the control-group. Thus, an estimated conversion probability (e.g., the second estimated probability) determined for the set of identified similar users would represent or approximate a conversion probability for the users associated with the second plurality of impressions as if those users were not to be provided with the second plurality of impressions.

Additionally or alternatively, in some implementations, the withheld impressions module 308 can identify the plurality of holdout impressions based on determining that at least a subset of the third set of features has a specified threshold level of similarity with respect to at least a subset of the second set of features. In such implementations, the withheld impressions module 308 identifies “shadow” or “counterfactual” impressions that are sufficiently similar to actual deliverable impressions, determines conversion probability (e.g., the second estimated probability) for these “shadow” or “counterfactual” impressions, but swaps out these “shadow” or “counterfactual” impressions before delivery time such that they are not delivered. Accordingly, the second estimated probability determined for these “shadow” or “counterfactual” impressions measures conversion likelihood when impression delivery is withheld, as opposed to when impression delivery occurs under the same circumstances (e.g., advertiser budgets, delivery patterns, objectives, bids, dates, times, seasonal effects, and/or competitors, etc.). As such, in some cases, one or more holdout impressions in the plurality of holdout impressions undergo one or more auction processes. Delivery of the one or more holdout impressions is withheld (e.g., swapped out) subsequent to the one or more holdout impressions undergoing the one or more auction processes.

Further, the lift metric module 310 is configured to facilitate generating an estimated metric measuring lifetime lift. In some embodiments, the lift metric module 310 generates the estimated metric measuring lifetime lift based on subtracting the second estimated probability from the first estimated probability. For example, the lift metric module 310 estimates a numeric value measuring lifetime lift (eLift) by taking the difference between the first estimated probability and the second estimated probability. Additionally, in some implementations, the lift metric module 310 facilitates generating an estimated effective cost per mile (eCPM) metric based on a sum of an organic value and a product value. The product value can be based on a multiplication of an event bid and the estimated metric measuring lifetime lift. It should be understood that many variations associated with the disclosed technology are possible.

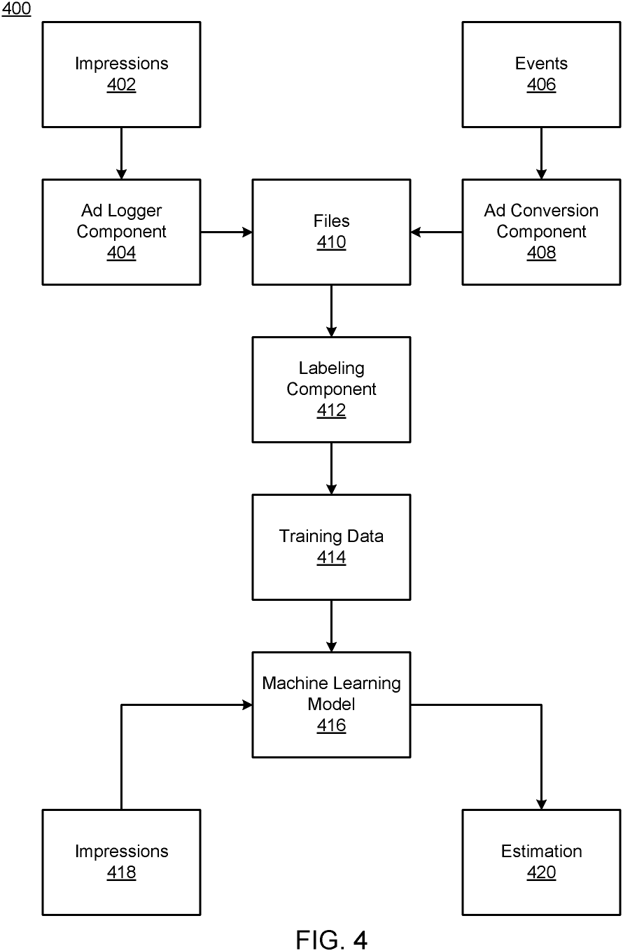

FIG. 4 illustrates a block diagram of an example scenario 400 associated with determining increased value based on holdout impressions, in accordance with an embodiment. In the example scenario 400 of FIG. 4, a first set of impressions 402 is logged by an ad logger component 404. The ad logger component 404 logs the first set of impressions 402 as well as a first set of features associated with the first set of impressions 402. In the example scenario 400, there is also a first set of events 406. An ad conversion component 408 logs a stream of events, including the first set of events 406. The set of logged events 406 can be associated with a set of conversions. The ad conversion component 408 matches events in the first set of events 406 (and their associated conversions) to impressions in the first set of impressions 402. One or more files 410 are generated based on the logged impressions 402, the features, the matched events 406, and/or the conversions associated with the events 406. Moreover, a labeling component 412 applies one or more label rules based on data stored in the one or more files 410. For instance, in accordance with a label rule, the labeling component 412 positively labels a subset of the first set of impressions 402 when conversions are attributable to the subset. In this instance, the labeling component 412 negatively labels another subset of the first set of impressions 402 when conversions are not attributable to the other subset. The one or more label rules can include criteria for defining what constitutes attribution. As a result of the labeling, training data 414 is formed. In some implementations, the ad logger component 404, the ad conversion component 408, and/or the labeling component 412 include, are included in, and/or are operable with the training data module 302.

Continuing with the example scenario 400, the training data 414 is utilized to train (i.e., generate, develop, build, refine, etc.) a machine learning model 416. The machine learning model 416 facilitates determining increased value based on holdout impressions. A second set of impressions 418 (including their associated features, events, and/or other data, etc.) that are deliverable to users can be applied or inputted to the machine learning model 416 to produce an estimation 420 of conversion likelihood when impression delivery occurs. Similarly, holdout impressions (including their associated features, events, and/or other data, etc.) can be applied or inputted to the machine learning model 416 to produce another estimation of conversion likelihood when impression delivery is withheld. The difference of the two estimations can be utilized to estimate increased value, such as an estimated metric measuring lifetime lift. Again, it should be appreciated that there can be many variations associated with the disclosed technology.

### Utilizing Holdout Impressions to Determine Increased Value

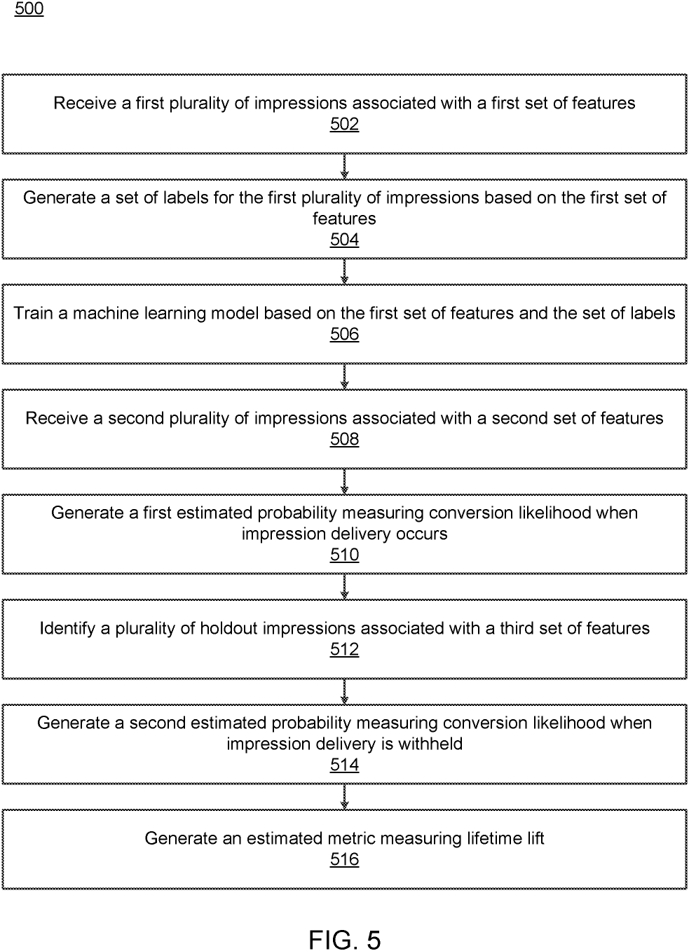

FIG. 5 illustrates a flowchart describing an example process 500 associated with determining increased value based on holdout impressions, in accordance with an embodiment. It should be understood that there can be additional, fewer, or alternative steps performed in similar or alternative orders, or in parallel, within the scope of the various embodiments unless otherwise stated.

In the example process 500, at block 502, a first plurality of impressions associated with a first set of features is received. At block 504, a set of labels for the first plurality of impressions is generated based on the first set of features. At block 506, the example process 500 includes training a machine learning model based on the first set of features and the set of labels. At block 508, a second plurality of impressions associated with a second set of features is received. At block 510, the example process 500 includes generating a first estimated probability measuring conversion likelihood when impression delivery occurs. The first estimated probability can be generated based on applying the second plurality of impressions and the second set of features to the machine learning model.

At block 512, a plurality of holdout impressions associated with a third set of features is identified. At block 514, the example process 500 includes generating a second estimated probability measuring conversion likelihood when impression delivery is withheld. The second estimated probability can be generated based on applying the plurality of holdout impressions and the third set of features to the machine learning model. At block 516, the example process 500 includes generating an estimated metric measuring lifetime lift. The estimated metric measuring lifetime lift can be generated based on subtracting the second estimated probability from the first estimated probability. Increased value can be represented via the estimated metric.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
accessing, by an online system, a machine learning model that outputs a probability that a user will perform a conversion action if the user is not provided an impression, where the machine learning model is trained by:
receiving a first set of features for each of a plurality of holdout impressions in which an impression delivery did not occur, where each holdout impression was selected from one or more auction processes but the impression delivery was withheld subsequent to the one or more auction processes because a user was in a holdout group for the impression;
receiving a set of labels for each of the plurality of holdout impressions, each label indicating whether a conversion occurred; and
training the machine learning model based on the set of features and the set of labels;
determining an opportunity to provide an impression to a viewing user of the online system;
receiving, by the online system, a second set of features associated with the opportunity to provide an impression to the viewing user;
generating, by the online system, based on the second set of features, a first estimated probability measuring conversion likelihood when impression delivery occurs;
generating, by the online system, based on applying the second set of features to the machine learning model, a second estimated probability measuring conversion likelihood when impression delivery is withheld; and
generating, by the online system, based on subtracting the second estimated probability from the first estimated probability, an estimated metric measuring lifetime lift.

2. The method of claim 1, wherein the plurality of holdout impressions is identified based on each user associated with each holdout impression in the plurality of holdout impressions, wherein each holdout impression in the plurality of holdout impressions is withheld from undergoing one or more auction processes, and wherein the impression delivery is withheld for each user associated with each holdout impression in the plurality of holdout impressions.

3. The method of claim 2, wherein identifying the plurality of holdout impressions further comprises:
determining that each user associated with each holdout impression in the plurality of holdout impressions matches, within an allowable deviation, a respective user associated with a respective impression in the second plurality of impressions.

4. (canceled)

5. The method of claim 1, wherein one or more holdout impressions in the plurality of holdout impressions undergo one or more auction processes, and wherein delivery of the one or more holdout impressions is withheld subsequent to the one or more holdout impressions undergoing the one or more auction processes.

6. The method of claim 1, wherein the plurality of holdout impressions is associated with a first set of events, and wherein the machine learning model is trained further based on the first set of events.

7. The method of claim 1, wherein the second set of features is associated with a second set of events, wherein the first estimated probability is generated further based on applying the second set of events to the machine learning model, wherein the plurality of holdout impressions is associated with a third set of events, and wherein the second estimated probability is generated further based on applying the third set of events to the machine learning model.

8. The method of claim 1, wherein the set of labels for the plurality of holdout impressions is generated based on a set of one or more label rules.

9. The method of claim 8, wherein the set of one or more label rules includes at least one label rule that requires a respective conversion in a plurality of conversions to be attributed to each impression in the plurality of holdout impressions.

10. The method of claim 1, further comprising:
generating an estimated effective cost per mile (eCPM) metric based on a sum of an organic value and a product value, the product value being based on a multiplication of an event bid and the estimated metric measuring lifetime lift.

11. A system comprising:
at least one processor; and
a memory storing instructions that, when executed by the at least one processor, cause the system to perform:
accessing, by an online system, a machine learning model that outputs a probability that a user will perform a conversion action if the user is not provided an impression, where the machine learning model is trained by:
receiving a first set of features for each of a plurality of holdout impressions in which an impression delivery did not occur, where each holdout impression was selected from one or more auction processes but the impression delivery was withheld subsequent to the one or more auction processes because a user was in a holdout group for the impression;
receiving a set of labels for each of the plurality of holdout impressions, each label indicating whether a conversion occurred; and
training the machine learning model based on the set of features and the set of labels;
determining an opportunity to provide an impression to a viewing user of the online system;
receiving, by the online system, a second set of features associated with the opportunity to provide an impression to the viewing user;
generating, by the online system, based on the second set of features, a first estimated probability measuring conversion likelihood when impression delivery occurs;
generating, by the online system, based on applying the second set of features to the machine learning model, a second estimated probability measuring conversion likelihood when impression delivery is withheld; and
generating, by the online system, based on subtracting the second estimated probability from the first estimated probability, an estimated metric measuring lifetime lift.

12. The system of claim 11, wherein the plurality of holdout impressions is identified based on each user associated with each holdout impression in the plurality of holdout impressions, wherein each holdout impression in the plurality of holdout impressions is withheld from undergoing one or more auction processes, and wherein the impression delivery is withheld for each user associated with each holdout impression in the plurality of holdout impressions.

13. The system of claim 12, wherein identifying the plurality of holdout impressions further comprises:
determining that each user associated with each holdout impression in the plurality of holdout impressions matches, within an allowable deviation, a respective user associated with a respective impression in the second plurality of impressions.

14. (canceled)

15. The system of claim 11, wherein one or more holdout impressions in the plurality of holdout impressions undergo one or more auction processes, and wherein delivery of the one or more holdout impressions is withheld subsequent to the one or more holdout impressions undergoing the one or more auction processes.

16. A non-transitory computer-readable storage medium including instructions that, when executed by at least one processor of a computing system, cause the computing system to perform a method comprising:
accessing, by an online system, a machine learning model that outputs a probability that a user will perform a conversion action if the user is not provided an impression, where the machine learning model is trained by:
receiving a first set of features for each of a plurality of holdout impressions in which an impression delivery did not occur, where each holdout impression was selected from one or more auction processes but the impression delivery was withheld subsequent to the one or more auction processes because a user was in a holdout group for the impression;
receiving a set of labels for each of the plurality of holdout impressions, each label indicating whether a conversion occurred; and
training the machine learning model based on the set of features and the set of labels;
determining an opportunity to provide an impression to a viewing user of the online system;
receiving, by the online system, a second set of features associated with the opportunity to provide an impression to the viewing user;
generating, by the online system, based on the second set of features, a first estimated probability measuring conversion likelihood when impression delivery occurs;
generating, by the online system, based on applying the second set of features to the machine learning model, a second estimated probability measuring conversion likelihood when impression delivery is withheld; and
generating, by the online system, based on subtracting the second estimated probability from the first estimated probability, an estimated metric measuring lifetime lift.

17. The non-transitory computer-readable storage medium of claim 16, wherein the plurality of holdout impressions is identified based on each user associated with each holdout impression in the plurality of holdout impressions, wherein each holdout impression in the plurality of holdout impressions is withheld from undergoing one or more auction processes, and wherein the impression delivery is withheld for each user associated with each holdout impression in the plurality of holdout impressions.

18. The non-transitory computer-readable storage medium of claim 17, wherein identifying the plurality of holdout impressions further comprises:
determining that each user associated with each holdout impression in the plurality of holdout impressions matches, within an allowable deviation, a respective user associated with a respective impression in the second plurality of impressions.

19. (canceled)

20. The non-transitory computer-readable storage medium of claim 16, wherein one or more holdout impressions in the plurality of holdout impressions undergo one or more auction processes, and wherein delivery of the one or more holdout impressions is withheld subsequent to the one or more holdout impressions undergoing the one or more auction processes.
